(19) United States
(12) Patent Application Publication
(10) Pub. No.: US 2019/0146129 A1
(43) Pub. Date: May 16, 2019

(54) LIGHT DIRECTING FILTERS

(71) Applicant: Faraday&Future Inc., Gardena, CA (US)

(72) Inventor: Mohammad Ali Mockarram-Dorri, Redondo Beach, CA (US)

(21) Appl. No.: 15/662,658

(22) Filed: Jul. 28, 2017

Related U.S. Application Data
(60) Provisional application No. 62/368,925, filed on Jul. 29, 2016.

(51) Int. Cl. G02B 5/20; G02B 27/01

(52) U.S. Cl. CPC G02B 5/20; G02B 27/0101

(57) ABSTRACT

A light directing filter may include one or more glass layers, one or more arrays of barriers within the glass layer, and one or more arrays of openings defined by the array(s) of barriers. An array of barriers may block transmission of light through the glass layer. An array of openings may allow transmission of light through the glass layer. One or more light directing filters may be included in a display system for a vehicle. The light directing filter(s) of the display system may allow a vehicle passenger to view visual information presented on the display system while not allowing a vehicle driver to view the visual information.

### CROSS-REFERENCE TO RELATED APPLICATIONS

This application claims the benefit of U.S. Provisional Application No. 62/368,925, filed Jul. 29, 2016, the entirety of which is hereby incorporated by reference.

### TECHNICAL FIELD

This disclosure relates to generally to the field of directing light, and more specifically to light directing filters.

### BACKGROUND

Vehicles may include entertainment systems with displays. For example, displays may present movies for viewing and/or games for playing by passengers of a vehicle. Displays that are visible to a driver of a vehicle (directly and/or through reflection on a windshield, etc.) may distract the driver.

### SUMMARY

This disclosure relates to light directing filters. A light directing filter may include one or more glass layers, one or more arrays of barriers within the glass layer, and one or more arrays of openings defined by the array(s) of barriers. A glass layer may have a first layer surface and a second layer surface. The second layer surface may be opposite to the first layer surface. A glass layer may have a first edge and a second edge. The second edge may be opposite to the first edge. The glass layer may have a third edge and a fourth edge. The fourth edge may be opposite to the third edge.

An array of barriers may be located between the first layer surface and the second layer surface of the glass layer. The array of barriers may block transmission of light through the glass layer. The array of barriers may block transmission of light between the first layer surface and the second layer surface. The array of barriers may block transmission of light incident on the array of barriers. In some implementations, the array of barriers may block transmission of light moving in a direction that is horizontally offset from a normal to the second layer surface by forty-six degrees and/or other degrees.

The array of barriers may include one or more sets of rows of barriers. The array of barriers may include a first set of rows of barriers arrayed between the first edge and the second edge of the glass layer. The first set of rows of barriers may include one or more portions. The first set of rows of barriers may include a first portion. Individual rows of barriers within the first portion may form different angles with the second layer surface.

In some implementations, one or more portions of the first set of rows of barriers may be symmetric to other portion(s) of the first set of rows of barriers. In some implementations, the first set of rows of barriers may include a second portion. Individual rows of barriers within the second portion may mirror the individual rows of barriers within the first portion.

In some implementations, the array of barriers may include a second set of rows of barriers arrayed between the third edge and the fourth edge. The second set of rows of barriers may include one or more portions. The second set of rows of barriers may include a third portion. Individual rows of barriers within the third portion may form different angles with the second layer surface.

In some implementations, the first set of rows of barriers may include a first part and the second set of rows of barriers may include a second part. The first part of the first set of rows of barriers may be orthogonal to the second part of the second set of rows of barriers.

An array of openings may allow transmission of light through the glass layer. The array of openings may allow transmission of light between the first layer surface and the second layer surface. The array of openings may allow transmission of light not incident on the array of barriers. In some implementations, the array of openings may allow transmission of light moving in a direction that is vertically offset from a normal to the second layer surface by twenty degrees and/or other degrees.

In some implementations, the array of openings may include multiple openings of different sizes. The array of openings may include a first opening, a second opening, and/or other openings. The second opening may be smaller than the first opening. The array of openings may include one or more shapes of openings. In some implementations, the first opening may include a polygonal opening. The polygonal opening may include four sides, six sides, and/or other number of sides.

A light directing filter may be made by providing a glass block for cutting. The glass block may have a first block surface and a second block surface. The second block surface may be opposite to the first block surface. The glass block may have one or more arrays of barriers within the glass block, and one or more arrays of openings defined by the array(s) of barriers.

A first array of barriers may be located between the first block surface and the second block surface of the glass block. The first array of barriers may block transmission of light through the glass block. The first array of barriers may block transmission of light between the first block surface and the second block surface. The first array of barriers may block transmission of light incident on the first array of barriers.

A first array of openings may be defined by the first array of barriers. The first array of openings may allow transmission of light between the first block surface and the second block surface. The first array of openings may allow transmission of light not incident on the first array of barriers.

A curved glass layer may be cut from the glass block. In some implementations, the curved glass layer may be cut from the glass block using a cylindrical curvature cut. In some implementations, the curved glass layer may be cut from the glass block using a spherical curvature cut.

The curved glass layer may be flattened. In some implementations, flattening the curved glass layer may include applying heat to the curved glass layer. The light directing filter may include the flattened glass layer.

In some implementations, the flattened glass layer may have a first layer surface and a second layer surface. The second layer surface may be opposite to the first layer surface. The flattened glass layer may have a first edge and a second edge. The second edge may be opposite to the first edge.

A second array of barriers may be located between the first layer surface and the second layer surface of the flattened glass layer. The second array of barriers may block transmission of light through the flattened glass layer. The second array of barriers may block transmission of light between the first layer surface and the second layer surface. The second array of barriers may block transmission of light incident on the second array of barriers.

The second array of barriers may include one or more sets of rows of barriers. The array of barriers may include a first set of rows of barriers arrayed between the first edge and the second edge of the flattened glass layer. The first set of rows of barriers may include one or more portions. The first set of rows of barriers may include a first portion. Individual rows of barriers within the first portion may form different angles with the second layer surface.

A second array of openings may be defined by the second array of barriers. The second array of openings may allow transmission of light between the first layer surface and the second layer surface. The second array of openings may allow transmission of light not incident on the second array of barriers.

One or more light directing filters may be included in a display system for a vehicle. A vehicle may include one or more display systems. A display system may allow a vehicle passenger to view visual information presented on the display system while not allowing a vehicle driver to view the visual information. The display system may provide visual information to a vehicle passenger while not providing the visual information to a vehicle driver when the vehicle passenger is seated in a front passenger seat and the vehicle driver is seated in a driver seat.

A display system may include one or more display screens and one or more light directing filters. A display screen may emit light conveying the visual information. The light directing filter may be positioned in front of the display screen. In some implementations, the display system may further include one or more protective glass layers. The light directing filter may be positioned between the display screen and the protective glass layer. The protective glass layer may be positioned between the display screen and the light directing filter.

In some implementations, the display system may be positioned with respect to the driver seat such that eyes of the vehicle driver seated in the driver seat are located forty-six degrees horizontally to the display system. In some implementations, the display system may be positioned with respect to the front passenger seat such that eyes of the vehicle passenger seated in the front passenger seat are located twenty degrees vertically above the display system.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1A illustrates a perspective view of a light directing filter in accordance with some implementations of the disclosure.

FIG. 1B illustrates a top-down view of a light directing filter in accordance with some implementations of the disclosure.

FIG. 1C illustrates a horizontal cross-sectional view of a light directing filter in accordance with some implementations of the disclosure.

FIG. 2A illustrates a perspective view of a light directing filter in accordance with some implementations of the disclosure.

FIG. 2B illustrates a top-down view of a light directing filter in accordance with some implementations of the disclosure.

FIG. 2C illustrates a vertical cross-sectional view of a light directing filter in accordance with some implementations of the disclosure.

FIG. 3A illustrates two exemplary openings in an array of openings in accordance with some implementations of the disclosure.

FIG. 3B illustrates exemplary opening shapes for an array of openings in accordance with some implementations of the disclosure.

FIGS. 4A-4D illustrate exemplary viewing angles for a light directing filter in accordance with some implementations of the disclosure.

FIG. 5 illustrates an exemplary display system in a vehicle in accordance with some implementations of the disclosure.

FIGS. 6A-6B illustrate exemplary configurations of a display system in accordance with some implementations of the disclosure.

FIGS. 7A-7B illustrate exemplary locations of a display system in a vehicle in accordance with some implementations of the disclosure.

FIG. 8 illustrates a method for making a light directing filter.

FIG. 9 illustrates a glass block in accordance with some implementations of the disclosure.

FIGS. 10A-10H illustrate different cuttings of a glass block in accordance with some implementations of the disclosure.

FIG. 11 illustrates an exemplary flattened glass layer in accordance with some implementations of the disclosure.

### DETAILED DESCRIPTION

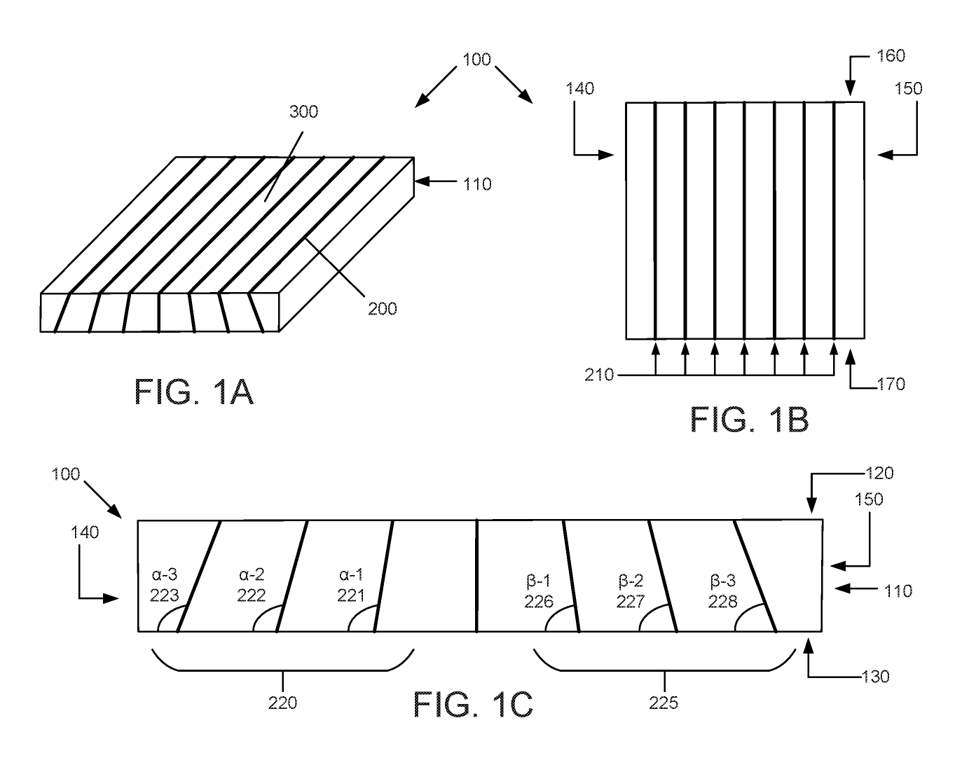

A light directing filter may include one or more glass layers, one or more arrays of barriers within the glass layer, and one or more arrays of openings defined by the array(s) of barriers. FIGS. 1A-1C illustrate exemplary light directing filter 100, with FIG. 1A illustrating a perspective view, FIG. 1B illustrating a top-down view, and FIG. 1C illustrating a horizontal cross-sectional view, in accordance with some exemplary implementations of the disclosure. Light directing filter 100 may include glass layer 110 and/or other glass layers. Glass layer 110 may have front layer surface 120, back layer surface 130, and/or other layer surfaces. Back layer surface 130 may be opposite to front layer surface 120. Glass layer 110 may have left edge 140, right edge 150, and/or other edges. Right edge 150 may be opposite to left edge 140. Glass layer 110 may have top edge 160 and bottom edge 170. Bottom edge 170 may be opposite to top edge 160. In some implementations, glass layer 110 may have a thickness of 0.5 millimeter to 1 millimeter. Other dimensions of glass layer 110 are contemplated.

Array of barriers 200 and/or other arrays of barriers may be located between front layer surface 120 and back layer surface 130 of glass layer 110. Array of barriers 200 may block transmission of light incident on the barriers 200, and thus may block transmission of light through glass layer 110 between front layer surface 120 and back layer surface 130. In some implementations, array of barriers 200 may include dimensions in tens to hundreds of micrometers. Other dimensions of array of barriers 200 are contemplated.

Array of barriers 200 may include one or more sets of rows of barriers, for example, a first set of rows of barriers 210 between left edge 140 and right edge 150 of glass layer 110. First set of rows of barriers 210 may include one or more portions. First set of rows of barriers 210 may include first portion 220. Individual rows of barriers within first portion 220 may form different angles with back layer surface 130. For example, as shown in FIG. 1C, individual rows of barriers within first portion 220 may form angles α-1 221, α-2 222, α-3 223, and/or other angles with back layer surface 130. Angle α-3 223 may be greater than angles α-1 221 and α-2 222. Angle α-2 222 may be greater than angle α-1 221.

In some exemplary implementations, one or more portions of first set of rows of barriers 210 may be symmetric to other portion(s) of first set of rows of barriers 210. For example, first set of rows of barriers 210 may include second portion 225. Individual rows of barriers within second portion 225 may mirror the individual rows of barriers within first portion 220. Angle β-1 226 may be supplementary to angle α-1 221. Angle β-2 227 may be supplementary to angle α-2 222. Angle β-3 228 may be supplementary to angle α-3 223. Other angles formed by individual rows of barriers are contemplated.

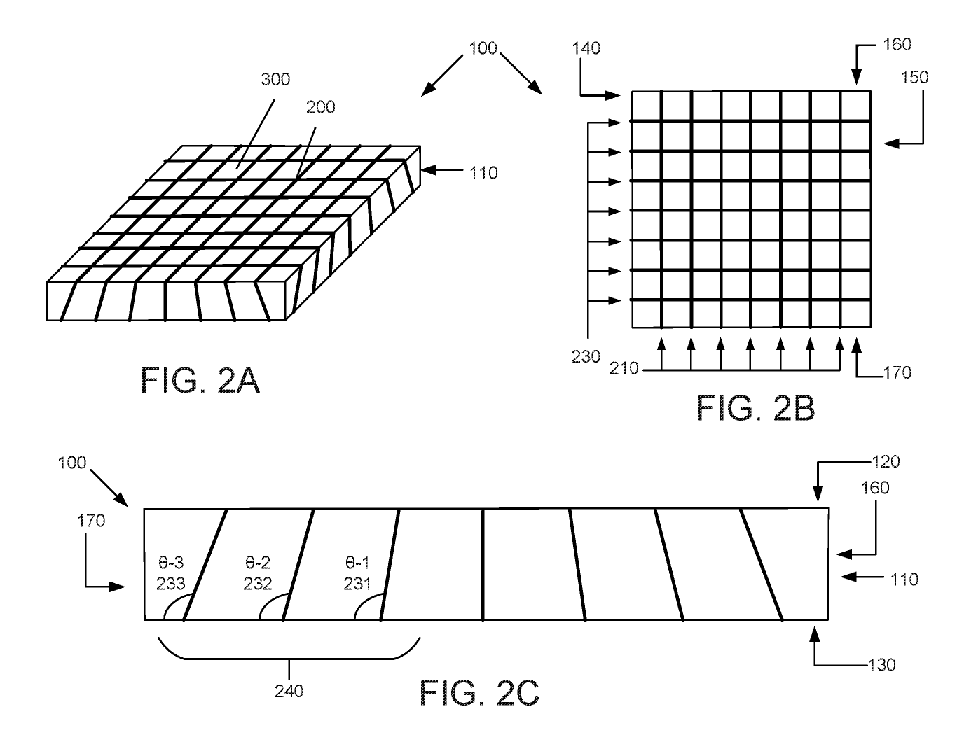

As shown in FIGS. 2A-2C, array of barriers 200 may include second set of rows of barriers 230 between top edge 160 and bottom edge 170. Second set of rows of barriers 230 may include one or more portions. For example, second set of rows of barriers may include third portion 240. Individual rows of barriers within third portion 240 may form different angles with back layer surface 130. For example, as shown in FIG. 2C, individual rows of barriers within third portion 240 may form angles θ-1 231, θ-2 232, α-3 233, and/or other angles with back layer surface 130. Angle θ-3 233 may be greater than angles θ-1 231 and θ-2 232. Angle θ-2 232 may be greater than angle θ-1 231.

In some exemplary implementations, one or more portions of first set of rows of barriers 210 may be orthogonal to one or more portions of second set of rows of barriers 230. As shown in FIG. 2B, first set of rows of barriers 210 and second set of rows of barriers 230 may intersect at multiple locations within glass layer 110. Portions of first set of rows of barriers 210 and portions of second set of rows of barriers 230 at the intersecting locations may be orthogonal to each other.

Array of openings 300 may allow transmission of light not incident on array of barriers 200, and thus allow transmission of light through glass layer 110 between front layer surface 120 and back layer surface 130.

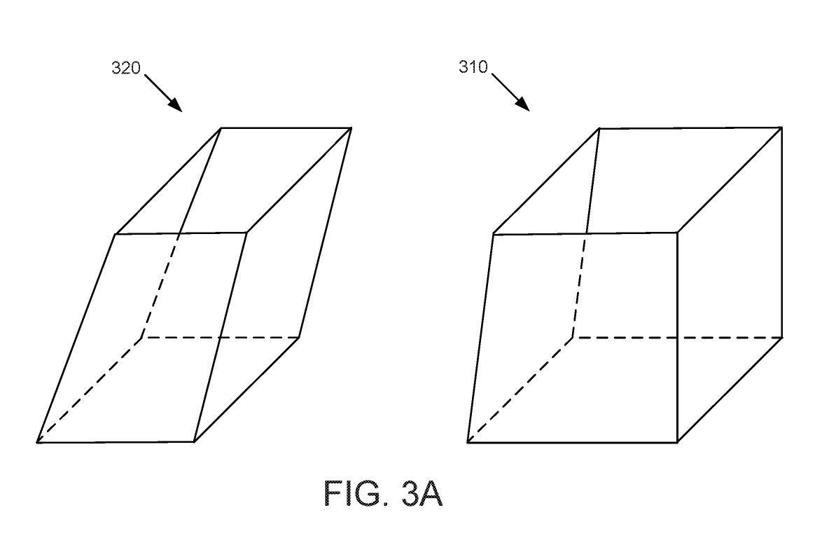

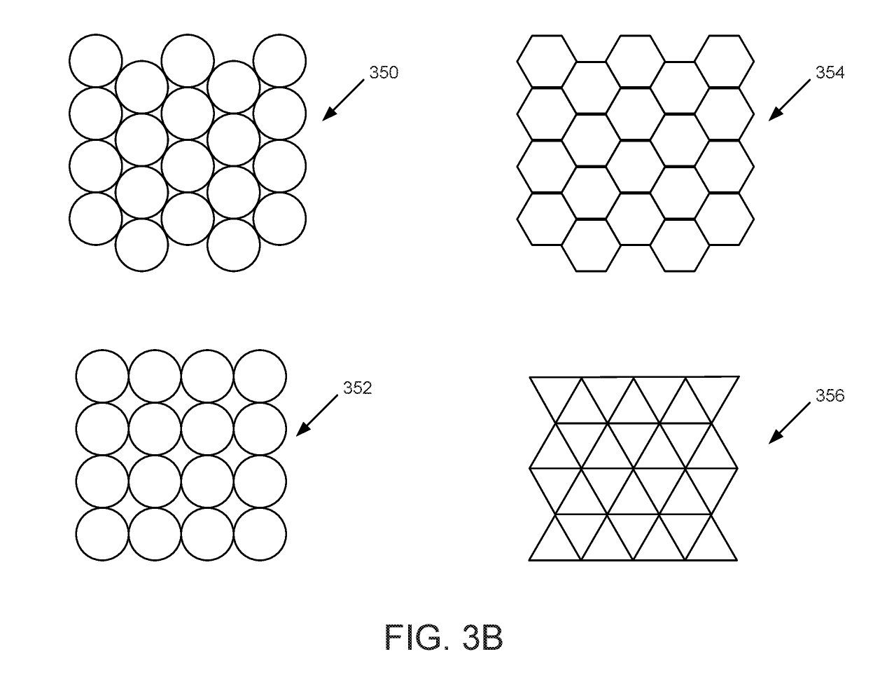

In some exemplary implementations, array of openings 300 may include multiple openings of different sizes. FIG. 3A illustrates two exemplary openings in array of openings 300. Array of openings 300 may include first opening 310, second opening 320, and/or other openings. Second opening 320 may be smaller than first opening 310. Other differing sizes of openings are contemplated.

In some implementations, array of openings 300 may include one or more different shapes of openings. As shown in FIGS. 1A-1C, in some implementations, the openings 300 may have a rectangular-shape cross-section. In some other implementations, as shown in FIGS. 2A-2C, the openings 300 may have a square-shape cross-section. Array of openings 300 may include polygonal openings, non-polygonal openings, and/or other openings. A polygonal opening may include four sides, six sides, and/or other number of sides. FIG. 3B illustrates exemplary opening shapes and configurations for array of openings 300. Opening shapes and configuration 350 may include staggered circular openings. Opening shapes and configuration 352 may include stacked circular openings. Opening shapes and configuration 354 may include staggered hexagonal openings. Opening shapes and configuration 356 may include stacked triangular openings. Other shapes of openings and configurations of openings are contemplated.

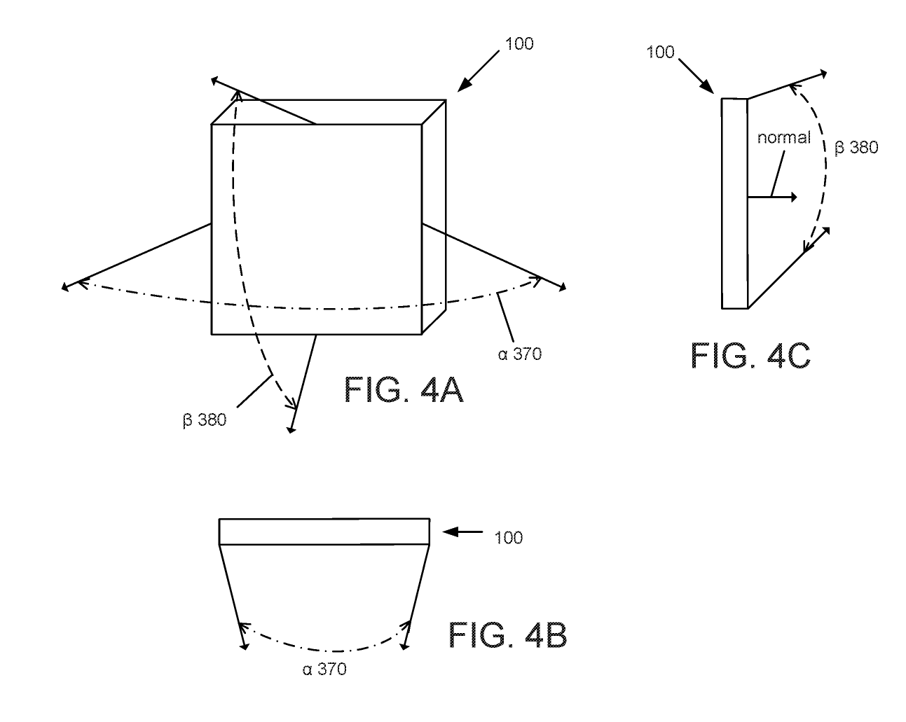

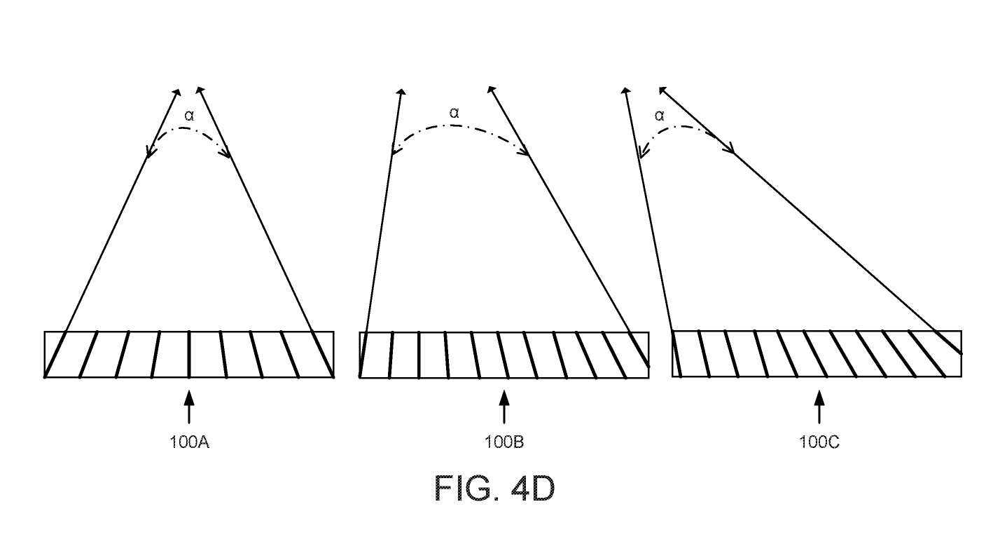

Array of barriers 200 and array of openings 300 may define one or more viewing angles for light directing filter 100. Viewing angles for light directing filter 100 may refer to maximum angles at which light transmitting through light directing filter 100 may be visible. FIGS. 4A-4D illustrate exemplary viewing angles for light directing filter 100. In FIG. 4A, angle α 370 may include a horizontal viewing angle for light directing filter 100. Angle β380 may include a vertical viewing angle for light directing filter 100. Other viewing angles are contemplated.

Viewing angles for light directing filter 100 may include converging viewing angles, deviating viewing angles, and/or other viewing angles. A converging viewing angle may refer to a viewing angle that narrows (e.g., angle α 370 shown in FIG. 4B). A deviating viewing angle may refer to a viewing angle that is offset from the normal to light directing filter 100 (e.g., angle β 380 shown in FIG. 4C).

FIG. 4D illustrates exemplary configurations of array of barriers and array of openings for light directing filters 100A, 100B, 100C. The configuration of array of barriers and array of openings in light directing filter 100A may result in a horizontal viewing angle that converges towards the center of light directing filter 100A. The configuration of array of barriers and array of openings in light directing filter 100B may result in a horizontal viewing angle that converges and deviates to the left of the center of light directing filter 100B. The configuration of array of barriers and array of openings in light directing filter 100C may result in a horizontal viewing angle that converges and deviates more to the left of the center of light directing filter 100C than the viewing angle of light directing filter 100B. Other configurations of array of barriers and array of openings are contemplated.

Array of barriers 200 and array of openings 300 may be configured to allow transmission of light from light directing filter 100 to one or more locations (e.g., to a location at a certain horizontal angle and a certain vertical angle with respect to light directing filter 100). For example, array of openings 300 may allow transmission to a certain distance of light moving in a direction that is vertically offset from a normal to back layer surface 130 by twenty degrees and/or other degrees. Array of barriers 200 and array of openings 300 may be configured to block transmission of light from light directing filter 100 to one or more locations (e.g., to a location at a certain horizontal angle and a certain vertical angle with respect to light directing filter 100). For example, array of barriers 200 may block transmission to a certain distance of light moving in a direction that is horizontally offset from a normal to back layer surface 130 by forty-six degrees and/or other degrees.

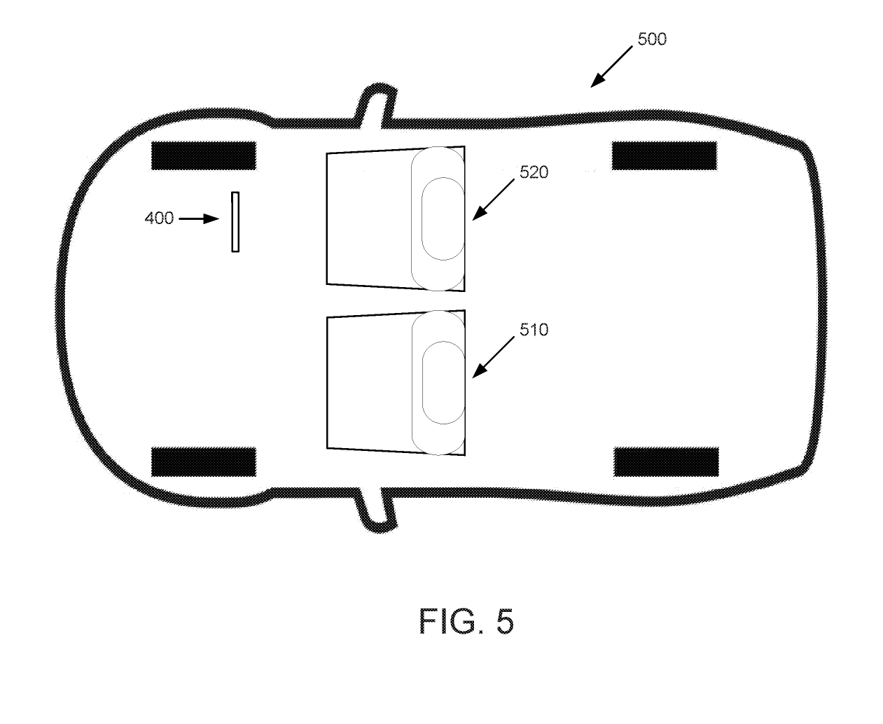

FIG. 5 illustrates exemplary display system 400 included in a vehicle 500 in accordance with some implementations of the disclosure. One or more light directing filters may be included in display system 400. One or more light directing filters within display system 400 may allow a vehicle passenger to view visual information presented on display system 400 while not allowing a vehicle driver to view the visual information. One or more light directing filters within display system 400 may allow display system 400 to provide visual information to a vehicle passenger when the vehicle passenger is seated in front passenger seat 520 while not providing the visual information to a vehicle driver when the vehicle driver is seated in driver seat 510.

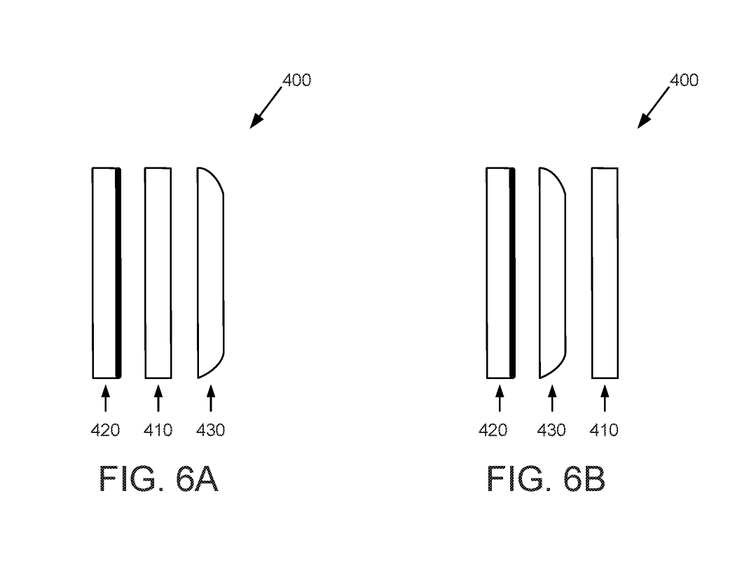

FIGS. 6A-6B illustrate exemplary configurations of display system 400. Display system 400 may include one or more light directing filters 410, display screens 420, and one or more protective glass layers 430. Display screen 420 may emit light conveying the visual information. Display screen 420 may use one or more displaying technologies (e.g., LED, LCD, Plasma, etc.) to emit light conveying the visual information. Protective glass layer 430 may protect light directing filter(s) 410 and/or display screen(s) 420. In FIG. 6A, light directing filter 410 may be positioned in front of display screen 420. Light directing filter 410 may be positioned between display screen 420 and protective glass layer 430. In FIG. 6B, protective glass layer 430 may be positioned in front of display screen 420. Protective glass layer 430 may be positioned between display screen 420 and light directing filter 410.

One or more components of display system 400 may be installed/removed/changed to change the viewing angles of display system 400. For example, a vehicle driver/vehicle passenger of vehicle 500 may install/remove/change light directing filter 410 in display system 400. Light directing filter 410 with certain horizontal viewing angle may be installed in display system 400 to prevent vehicle driver of vehicle 500 from seeing what is presented by display screen 420. Light directing filter 410 having a certain vertical viewing angle may be changed with another light directing filter 410 having a different vertical viewing angle to reduce the amount of reflection from display screen 420 on a windshield.

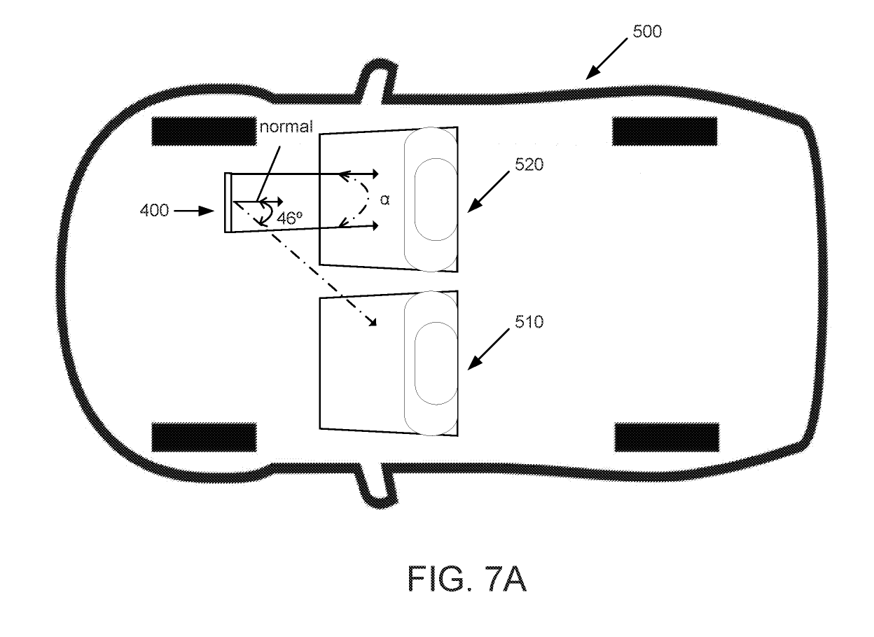

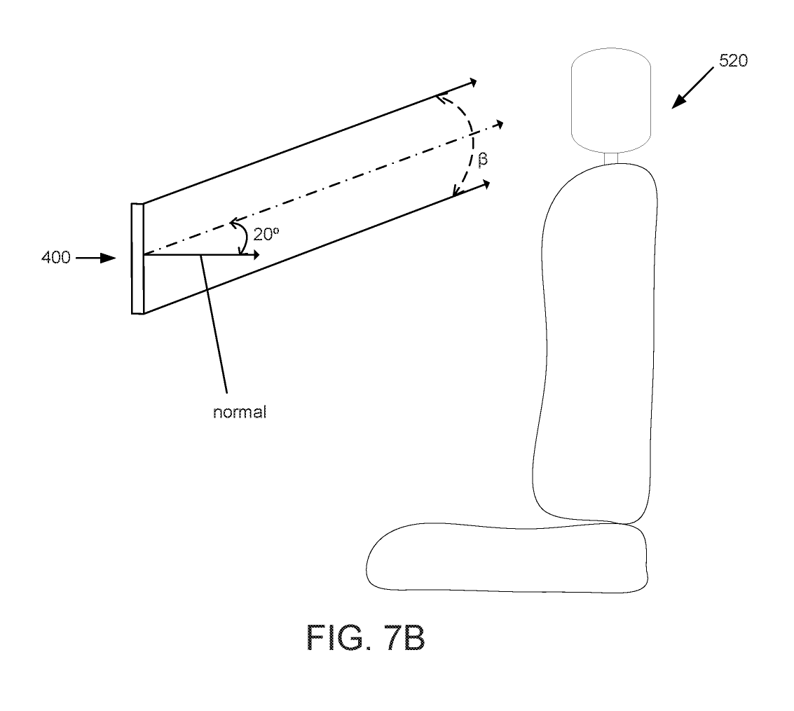

As shown in FIG. 7A, display system 400 may be positioned with respect to driver seat 510 such that eyes of the vehicle driver seated in driver seat 510 are located forty-six degrees horizontally to display system 400. Array of barriers within light directing filter 410 of display system 400 may block transmission of light to eyes of the vehicle driver seated in driver seat 510. In some implementations, the array of barriers within light directing filter 410 of display system 400 may block transmission of light to eyes of the 95th percentile of projected vehicle drivers.

As shown in FIG. 7B, display system 400 may be positioned with respect to front passenger seat 520 such that eyes of the vehicle passenger seated in the front passenger seat 520 are located twenty degrees vertically above display system 400. Array of openings within light directing filter 410 of display system 400 may allow transmission of light to eyes of the vehicle passenger seated in front passenger seat 520. In some implementations, the array of openings within light directing filter 410 of display system 400 may allow transmission of light to eyes of the 95th percentile of projected vehicle passengers.

Array of barriers within light directing filter 410 of display system 400 may block/reduce transmission of light to one or more windows (e.g., front passenger window in FIG. 7A, front windshield in FIG. 7B, etc.) of vehicle 500. Blocking/reducing transmission of light to one or more windows of vehicle 500 may block/reduce transmission of light (e.g., via reflection, etc.) to eyes of the vehicle driver seated in driver seat 510. In some implementations, the array of barriers within light directing filter 410 of display system 400 may block/reduce transmission of light (e.g., via reflection, etc.) to the eyes of the 95th percentile of projected vehicle drivers.

Although display system 400 is shown to be located directly in front of front passenger seat 520, this is merely for ease of reference of is not limiting. Display system 400 may be placed in other locations within vehicle 500.

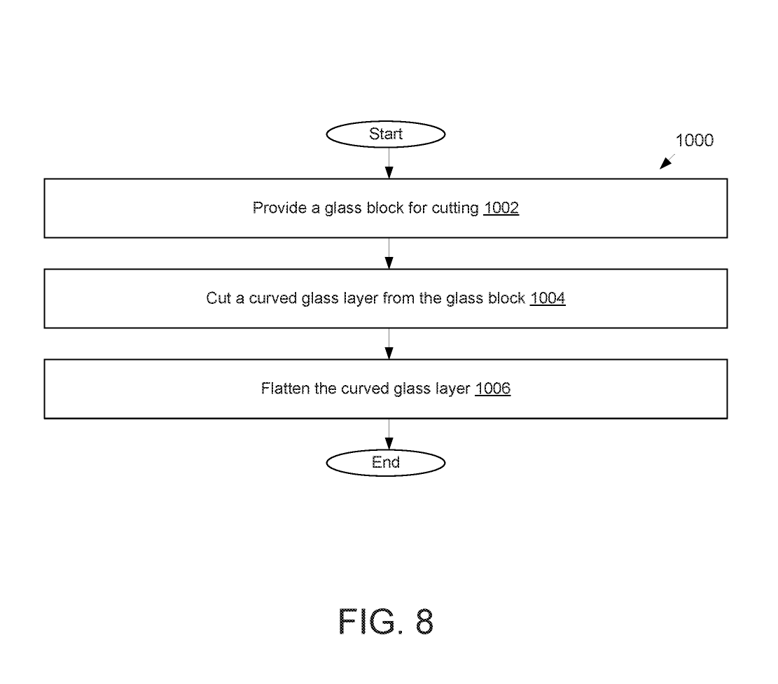

FIG. 8 illustrates method 1000 for making a light directing filter. The operations of method 1000 presented below are intended to be illustrative. In some implementations, method 1000 may be accomplished with one or more additional operations not described, and/or without one or more of the operations discussed. In some implementations, two or more of the operations may occur substantially simultaneously.

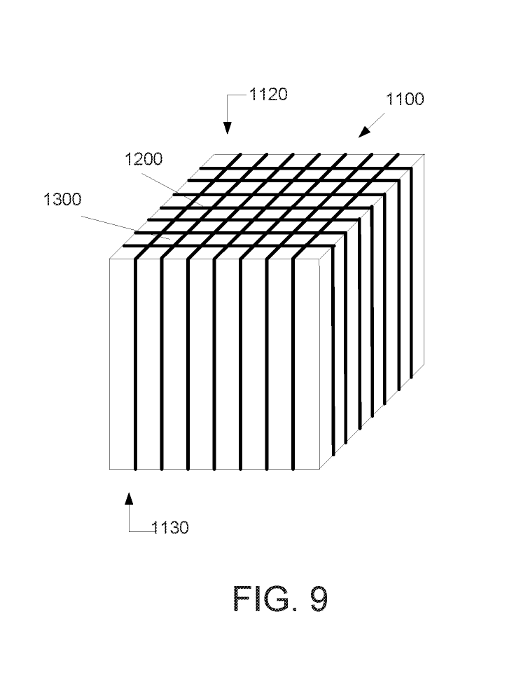

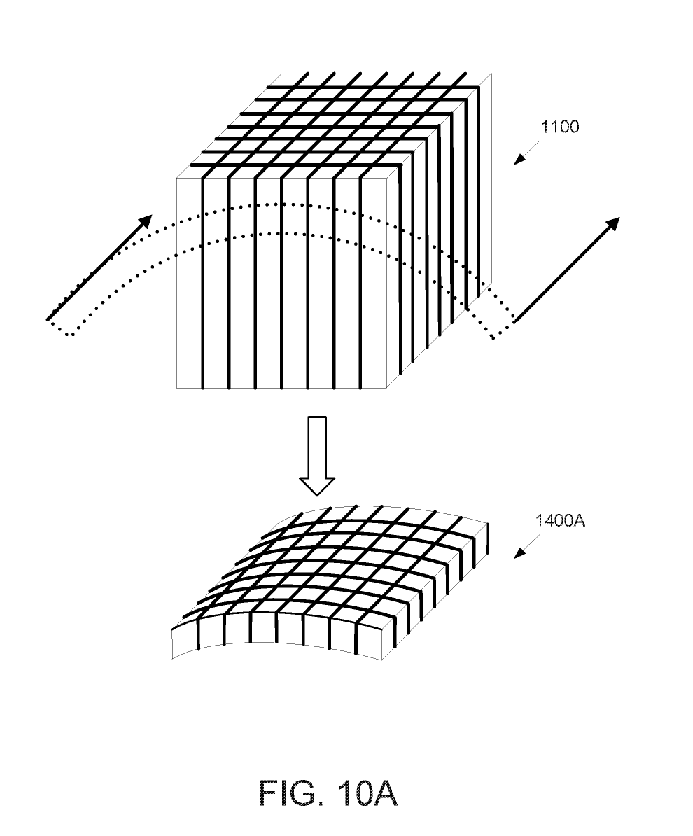

At operation 1002, glass block 1100 may be provided for cutting. FIG. 9 illustrates exemplary glass block 1100 in accordance with some implementations on the disclosure. Other shapes and configurations of glass block 1100 are contemplated.

Glass block 1100 may have front block surface 1120, back block surface 1130, and/or other block surfaces. Back block surface 1130 may be opposite to front block surface 1120. Glass block 1100 may have one or more arrays of barriers within glass block 1100, and one or more arrays of openings defined by the array(s) of barriers.

Array of barriers 1200 may be located between front block surface 1120 and back block surface 1130 of glass block 1100. Array of barriers 1200 may block transmission of light through glass block 1100. Array of barriers 1200 may block transmission of light between front block surface 1120 and back block surface 1130. Array of barriers 1200 may block transmission of light incident on array of barriers 1200.

Array of openings 1300 may be defined by array of barriers 1200. Array of openings 1300 may allow transmission of light between front block surface 1120 and back block surface 1130. Array of openings 1300 may allow transmission of light not incident on array of barriers 1200.

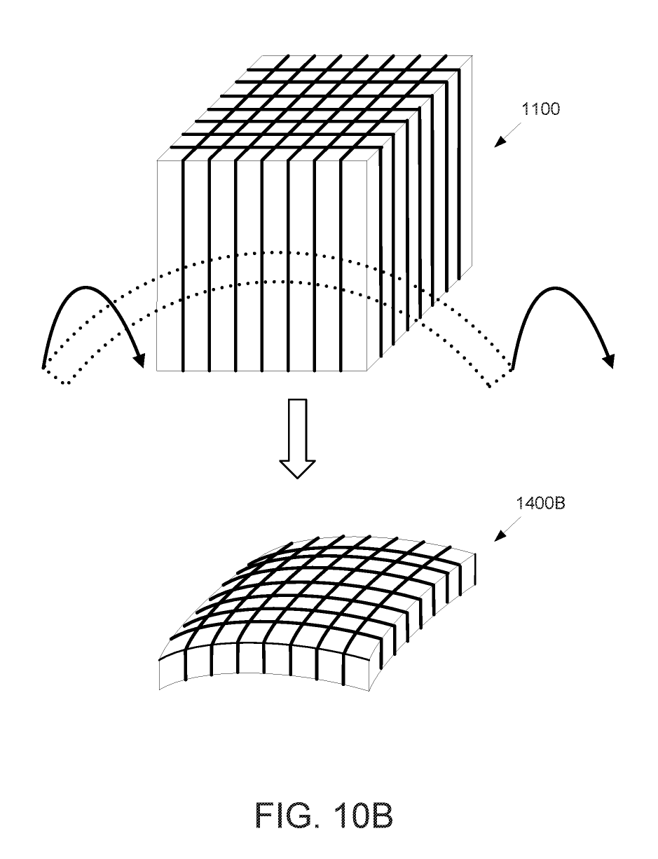

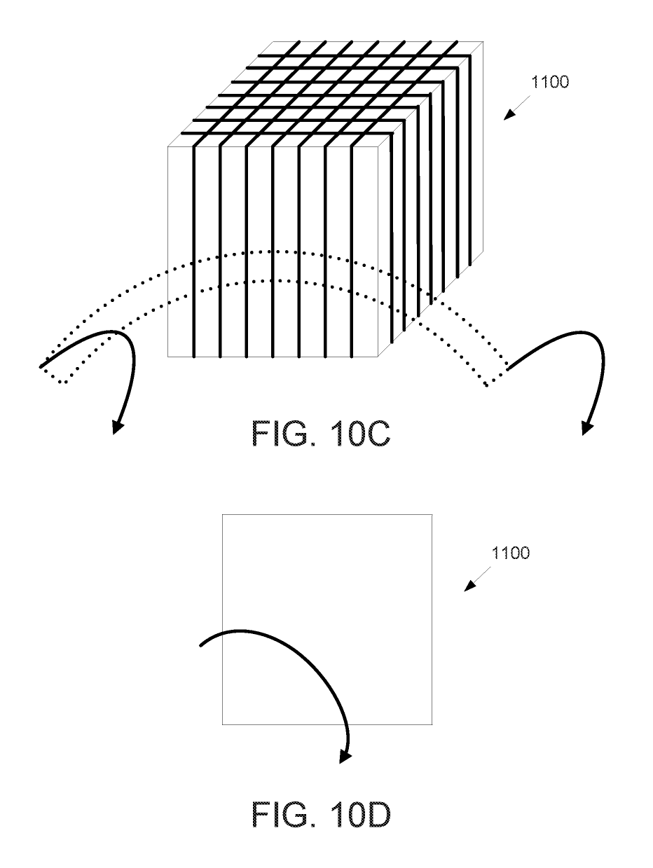

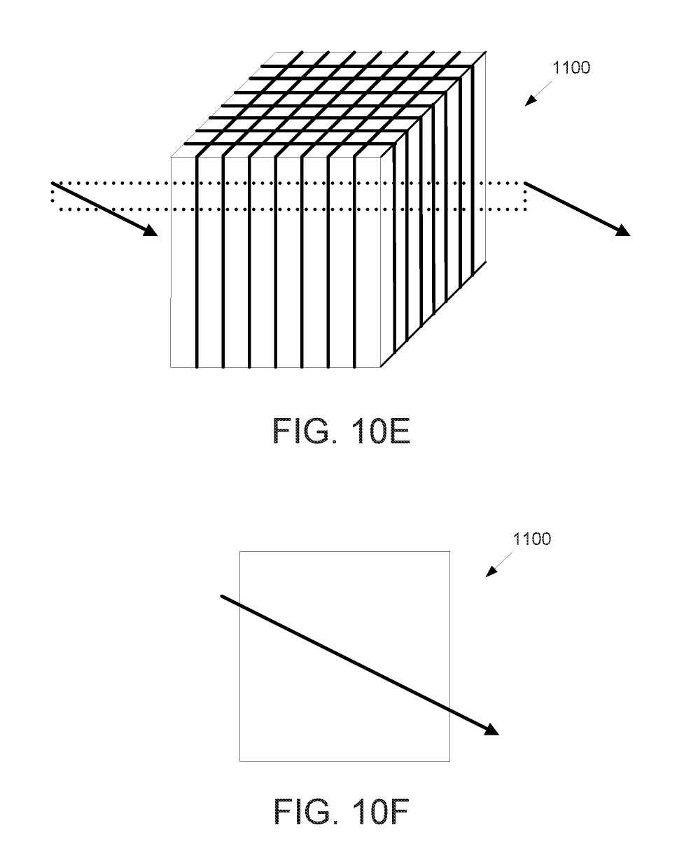

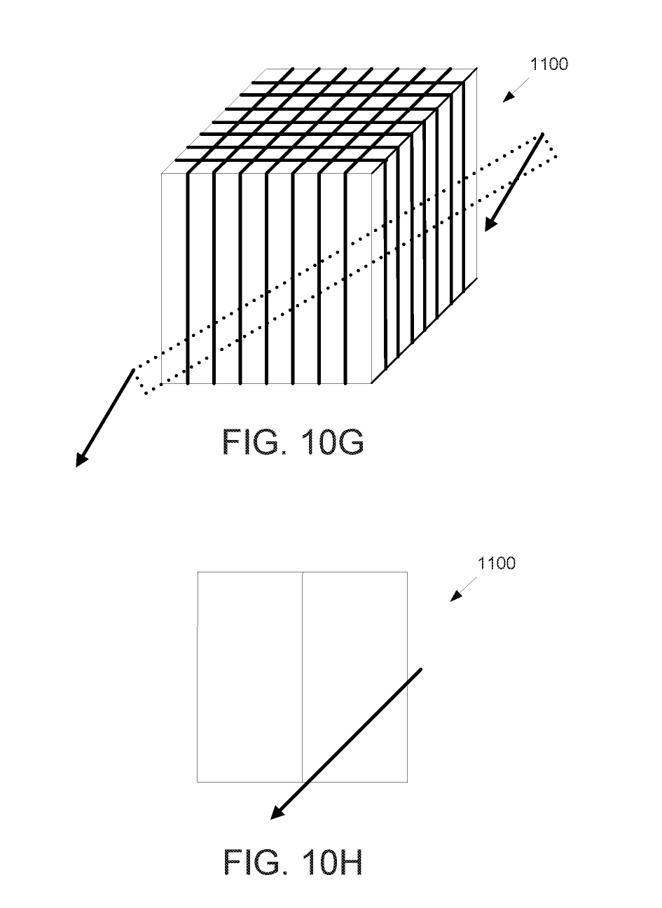

At operation 1004, curved glass layer 1400 may be cut from glass block 1100. Curved glass layer 1400 may be cut from glass block 1100 using one or more curvatures. For example, curved glass layer 1400 may be cut from glass block 1100 using a cylindrical curvature cut as shown in FIG. 10A. The cylindrical curvature cut shown in FIG. 10A may result in curved glass layer 1400A. Curved glass layer 1400A may include a cylindrical curvature. Curved glass layer 1400 may be cut from glass block 1100 using a spherical curvature cut as shown in FIG. 10B. The spherical curvature cut shown in FIG. 10B may result in curved glass layer 1400B. Curved glass layer 1400B may include a spherical curvature.

FIGS. 10C-10H illustrate other different cuttings of glass block 1100. In FIG. 10C, glass block 1100 may be cut with an elliptical cut. FIG. 10D illustrates the path taken by the elliptical cut from a side-view of glass block 1100. In FIG. 10E, glass block 1100 may be cut with a diagonal cut. FIG. 10F illustrates the path taken by the diagonal cut from a side-view of glass block 1100. In FIG. 10G, glass block 1100 may be cut with a diagonal cut at a corner of glass block 1100. FIG. 10H illustrates the path taken by the diagonal cut at the corner of glass block 1100 from a side-view of glass block 1100. Other cuttings of glass block 1100 are contemplated.

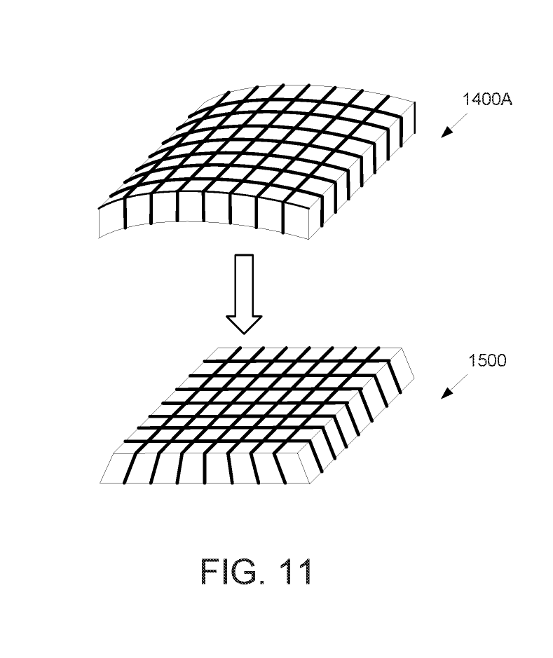

At operation 1006, curved glass layer 1400 may be flattened. For example, curved glass layer 1400A (having cylindrical curvature) may be flattened into flattened glass layer 1500 shown in FIG. 11. Flattened glass layer 1500 may include one or more arrays of barriers and one or more arrays of openings defined by the array(s) of barriers, as described herein. A light directing filter may include flattened glass layer 1500. In some implementations, flattening curved glass layer 1400 may include applying heat to curved glass layer 1400. Heat may be applied uniformly or non-uniformly across curved glass layer 1400. Applying heat to curved glass layer 1400 may include one or more durations in which the temperature of the heat applied is increased, steady, or decreasing.

Spatially relative terms such as “under,” “below,” “lower,” “over,” “upper,” and the like, are used for ease of description to explain the positioning of one element relative to a second element. These terms are intended to encompass different orientations of the device in addition to different orientations than those depicted in the figures. Further, terms such as “first,” “second,” and the like, are also used to describe various elements, regions, sections, etc. and are also not intended to be limiting. Like terms refer to like elements throughout the description.

As used herein, the terms “having,” “containing,” “including,” “comprising,” and the like are open ended terms that indicate the presence of stated elements or features, but do not preclude additional elements or features. The articles “a,” “an” and “the” are intended to include the plural as well as the singular, unless the context clearly indicates otherwise.

Although this invention has been disclosed in the context of certain implementations and examples, it will be understood by those skilled in the art that the present invention extends beyond the specifically disclosed implementations to other alternative implementations and/or uses of the invention and obvious modifications and equivalents thereof. Thus, it is intended that the scope of the present invention herein disclosed should not be limited by the particular disclosed implementations described above.

Furthermore, the skilled artisan will recognize the interchangeability of various features from different implementations. In addition to the variations described herein, other known equivalents for each feature can be mixed and matched by one of ordinary skill in this art to construct analogous systems and techniques in accordance with principles of the present invention.

It is to be understood that not necessarily all objects or advantages may be achieved in accordance with any particular implementation of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

What is claimed is:

1. A light directing filter comprising:
a glass layer, the glass layer having:
a first layer surface and a second layer surface opposite to the first layer surface; and
a first edge and a second edge opposite to the first edge;
an array of barriers within the glass layer, the array of barriers located between the first layer surface and the second layer surface, the array of barriers blocking transmissions of light, incident on the array of barriers, between the first layer surface and the second layer surface; and
an array of openings defined by the array of barriers, the array of openings allowing transmission of light between the first layer surface and the second layer surface;
wherein:
the array of barriers includes a first set of rows of barriers arrayed between the first edge and the second edge, the first set of rows of barriers including a first portion and individual rows of barriers within the first portion forming different angles with the second layer surface.

2. The light directing filter of claim 1, wherein the array of openings includes a first opening and a second opening, the second opening being smaller than the first opening.

3. The light directing filter of claim 1, wherein the first set of rows of barriers further includes a second portion and individual rows of barriers within the second portion mirror the individual rows of barriers within the first portion.

4. The light directing filter of claim 1, wherein:
the glass layer further has a third edge and a fourth edge opposite to the third edge;
the array of barriers further includes a second set of rows of barriers arrayed between the third edge and the fourth edge, the second set of rows of barriers including a third portion and individual rows of barriers within the third portion forming different angles with the second layer surface.

5. The light directing filter of claim 4, wherein at least a first part of the first set of rows of barriers and a second part of the second set of rows of barriers are orthogonal to each other.

6. The light directing filter of claim 1, wherein the first opening includes a polygonal opening.

7. The light directing filter of claim 6, wherein the polygonal opening includes four sides.

8. The light directing filter of claim 6, wherein the polygonal opening includes six sides.

9. The light directing filter of claim 1, wherein the array of barriers blocks transmission, between the first layer surface and the second layer surface, of light moving in a direction that is horizontally offset from a normal to the second layer surface by forty-six degrees.

10. The light directing filter of claim 1, wherein the array of openings allows transmission, between the first layer surface and the second layer surface, of light moving in a direction that is vertically offset from a normal to the second layer surface by twenty degrees.

11. A method for making a light directing filter, the method comprising:
providing a glass block for cutting, the glass block having a first block surface and a second block surface opposite to the first block surface, the glass block including:
a first array of barriers located between the first block surface and the second block surface, the first array of barriers blocking transmissions of light, incident on the first array of barriers, between the first block surface and the second block surface;
a first array of openings defined by the first array of barriers, the first array of openings allowing transmission of light between the first block surface and the second block surface;
cutting a curved glass layer from the glass block; and
flattening the curved glass layer.

12. The method of claim 11, wherein flattening the curved glass layer includes applying heat to the curved glass layer.

13. The method of claim 11, wherein the curved glass layer is cut from the glass block using a cylindrical curvature cut.

14. The method of claim 11, wherein the curved glass layer is cut from the glass block using a spherical curvature cut.

15. The method of claim 11, wherein the flattened glass layer has a first layer surface and a second layer surface opposite to the first layer surface, and a first edge and a second edge opposite to the first edge, the flattened glass layer including:
a second array of barriers within the flattened glass layer, the second array of barriers located between the first layer surface and the second layer surface, the second array of barriers blocking transmissions of light, incident on the second array of barriers, between the first layer surface and the second layer surface; and
a second array of openings defined by the second array of barriers, the second array of openings allowing transmission of light between the first layer surface and the second layer surface;
wherein the second array of barriers includes a first set of rows of barriers arrayed between the first edge and the second edge, the first set of rows of barriers including a first portion and individual rows of barriers within the first portion forming different angles with the second layer surface.

16. A vehicle comprising:
a display system for providing visual information to a vehicle passenger while not providing the visual information to a vehicle driver when the vehicle passenger is seated in a front passenger seat and the vehicle driver is seated in a driver seat, the display system comprising:
a display screen emitting light conveying the visual information;
a light directing filter positioned in front of the display screen, the light directing filter comprising:
a glass layer, the glass layer having:
a first layer surface and a second layer surface opposite to the first layer surface; and
a first edge and a second edge opposite to the first edge;
an array of barriers within the glass layer, the array of barriers located between the first layer surface and the second layer surface, the array of barriers blocking transmissions of light, incident on the array of barriers, between the first layer surface and the second layer surface; and
an array of openings defined by the array of barriers, the array of openings allowing transmission of light between the first layer surface and the second layer surface;
wherein the array of barriers includes a first set of rows of barriers arrayed between the first edge and the second edge, the first set of rows of barriers including a first portion and individual rows of barriers within the first portion forming different angles with the second layer surface.

17. The vehicle of claim 16, wherein the display system further comprises a protective glass layer, the light directing filter positioned between the display screen and the protective glass layer.

18. The vehicle of claim 16, wherein the display system further comprises a protective glass layer, the protective glass layer positioned between the display screen and the light directing filter.

19. The vehicle of claim 16, wherein the display system is positioned with respect to the driver seat such that eyes of the vehicle driver seated in the driver seat are located forty-six degrees horizontally to the display system.

20. The vehicle of claim 16, wherein the display system is positioned with respect to the front passenger seat such that eyes of the vehicle passenger seated in the front passenger seat are located twenty degrees vertically above the display system.
